(19) United States
(12) Patent Application Publication
(10) Pub. No.: US 2003/0225492 A1
(43) Pub. Date: Dec. 4, 2003

(54) Flight data transmission via satellite link and ground storage of data

(76) Inventors: Gary G. Cope, Longmont, CO (US); Gregory L. Kaufman, West Toluca Lake, CA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/441,441

(22) Filed: May 19, 2003

Related U.S. Application Data
(60) Provisional application No. 60/385,767, filed on Jun. 3, 2002.
(60) Provisional application No. 60/384,485, filed on May 29, 2002.

(51) Int. Cl. G06F 19/00

(52) U.S. Cl. 701/35; 701/14; 340/945

(57) ABSTRACT

A flight data transmission and storing system includes an on-board flight monitoring component for gathering standard flight data, including flight statistics and cockpit voice data, on an airplane and transmitting the data via a commercial or private satellite network to a central data repository at a secure location on the ground. The data may be sent in Internet Protocol (IP) format or other proven communication format for voice/data transmission. The flight data preferably is relayed to a data repository maintained by the FAA or other responsible governmental agency or licensed partner. The flight data can then be immediately retrieved in the event of an accident, to assist in a mid-flight crisis, for preventative or predictive maintenance, and/or for flight personnel training.

### BACKGROUND OF THE INVENTION

1. Field of the Invention

This invention is in the field of recording aircraft flight data and more particularly to recording and transmitting the flight data for storage in a ground location while the aircraft is in flight.

2. Description of the Related Art

Larger commercial aircraft and some smaller commercial, corporate, and private aircraft are required by the FAA to be equipped with “black boxes” that record information about a flight. Usually two recorders are installed to help reconstruct the events leading to an aircraft accident. One of these, the cockpit voice recorder (CVR), records radio transmission and sounds in the cockpit, such as the pilot's voices and engine noises. The recorder's “cockpit area microphone” is usually located on the overhead instrument panel between the two pilots. Sounds of interest captured include engine noise, stall warnings, landing gear extension and retraction, and other clicks and pops. From these sounds, parameters such as engine rpm, system failures, speed, and the time at which certain events occur can often be determined. Communications with Air Traffic Control, automated radio weather briefings, and conversation between the pilots and ground or cabin crew are also recorded as well as knocks on doors and intrusions.

The other, the flight data recorder (FDR), monitors parameters such as altitude, airspeed and heading. The older analog units use one-quarter inch magnetic tape as a storage medium and the newer ones use digital technology and memory chips. Both recorders are installed in the most crash survivable part of the aircraft, usually the tail section. Airplanes are equipped with sensors that gather data. There are sensors that detect acceleration, airspeed, altitude, flap settings, outside temperature, cabin temperature and pressure, engine performance and more. Magnetic-tape recorders can track about 100 parameters, while solid-state recorders can track more than 700 in larger aircraft. On Jul. 17, 1997, the FAA issued a Code of Federal Regulations that requires the recording of at least 88 parameters on aircraft manufactured after Aug. 19, 2002.

All of the data collected by the airplane's sensors is sent to the flight-data acquisition units (FDAU) at the front of the aircraft. This device often is located in the electronic equipment bay under the cockpit. The flight-data acquisition unit is the middle manager of the entire data-recording process. It takes the information from the sensors and sends it on to the black boxes.

Most of the black boxes in use today use magnetic tape, which was first introduced in the 1960s, or solid-state memory boards, which came along in the 1990s. Magnetic tape works like any tape recorder. The Mylar tape is pulled across an electromagnetic head, which leaves a bit of data on the tape. Black-box manufacturers are no longer making magnetic tape recorders as airlines begin a full transition to solid-state technology.

Solid-state recorders are considered much more reliable than their magnetic-tape counterparts. Solid state uses stacked arrays of memory chips, so they don't have moving parts. With no moving parts, there are fewer maintenance issues and a decreased chance of something breaking during a crash. Data from both the CVR and FDR is stored on the stacked memory boards inside the crash-survivable memory unit (CSMU).

When recovered, both the flight data recorder and the cockpit voice recorder have proven to be valuable tools in the accident investigation process. They can provide information that may be difficult or impossible to obtain by other means. When used in conjunction with other information gained in the investigation, the recorders are playing an ever-increasing role in determining the probable cause of an aircraft accident. With the data retrieved from the FDR, the Safety Board can generate a computer animated video reconstruction of the flight. The investigator can then visualize the airplane's attitude, instrument readings, power settings and other characteristics of the flight. This animation enables the investigating team to visualize the last moments of the flight before the accident.

There are a number of shortcomings with analyzing the data stored in today's black boxes, such as the flight data recorder, and the cockpit voice recorder. A first shortcoming is that the recovery of the black boxes is time consuming and difficult. There are numerous instances in which the black boxes has not been recovered or, large amounts of money and time are expended in recovering the black boxes. A further disadvantage of storing data in the black boxes is that the black boxes may be destroyed in a crash so that, even if the black boxes themselves are found, the data located therein cannot be recovered.

A significant downside of the black boxes is the small amount of data which is recorded. In standard black boxes, this is often only the last 30 minutes of the flight data and the last 30 minutes of the audible cockpit noises. This is because the black boxes have a limited amount of storage space and continuously record new data on top of the oldest data so that at any one time, the black boxes have stored therein only the last amount of data depending on the storage capability of the specific black box. Many times, it would be helpful to have data associated with the takeoff, or other events which occurred several hours prior to the start of the black box data record.

### BRIEF SUMMARY OF THE INVENTION

According to principles of the present invention, a flight data acquisition system is also equipped with an air relay module that includes a transmission module. As flight data is accumulated and sent to the flight data recorder for storage, the transmission module is available for instantaneously sending the same data to a satellite for transmission from the satellite to a ground storage system. The data may then be collected and stored at a ground storage system or, reviewed instantaneously by ground personnel in order to understand flight conditions.

According to one embodiment of the present invention, the transmission of data for ground storage is performed only on the occurrence of selected conditions. When the flight starts, a number of flight parameters are stored in the air relay module. These flight parameters include such items as the flight number, the departure airport, the destination airport, the route to be followed, the beacon code, as well as other expected flight parameters. As the flight progresses, all of the flight parameters are monitored by the air relay module. The air relay module has stored therein expected locations for the aircraft based on its stored route and destination point. It also has stored therein expected flight parameters for standard operating conditions for an aircraft of this type. In one embodiment, when the flight first takes off, a log transmission is carried out in order to transmit via satellite to the ground receiving station a first data acquisition point as well as confirm proper operation of the equipment. No further transmissions or data are sent at this time. As long as the aircraft continues on the expected route and within the expected operating parameters, no transmission is sent to the ground.

If at any time during the flight an alert event occurs, then the air relay module will instantaneously begin to transmit the current flight information for storage on the ground which is the same data being sent to the cockpit voice recorder and the flight data recorder.

An alert event may be any number of potential events. For example, if the aircraft has strayed from its established route by greater than a threshold distance. Other alert events may be that the aircraft has experienced a very sharp turn beyond a normal expected operating condition of the aircraft, a sharp change in altitude or an unexpected change in position of one of the flight control surfaces. Further, the cockpit will include an alert button that the crew may press in order to initiate an alert event. The crew may thus trigger the transmissions of the data to the satellite network for subsequent storage.

In an alternative embodiment, the system further includes an emergency transmit module. The emergency transmit module is coupled to the data stored in the black boxes. If the emergency transmit module is activated, then all the data which is currently stored in the flight data recorder and cockpit voice recorder over the previous portion of the flight is downloaded rapidly into the emergency transmit module and compressed for immediately transmission. The entire content of the storage data within the recorders is thereafter immediately transmitted to the storage location. Since such transmission is done digitally and of compressed data, the entire contents of the data can be transmitted in a short period of time, for example, less than five minutes, or in some instances less than one minute, so that in addition to capturing and transmitting the instantaneous flight parameters, the previous set of stored data has also been transmitted for ground storage and later analysis.

According to one embodiment, the alert module has two possible alert states it may enter. The first alert state is a deviation alert and a second state is a disaster alert. The deviation alert may be activated by an unexpected route location or sudden changes in the aircraft beyond the expected operating parameters. This causes the data to begin to be transmitted by the transmitter in the air relay module. In those situations in which the changes in the aircraft are beyond a first threshold deviation and become sufficient to indicate a potential crash, the disaster alert may be triggered. A disaster alert would be a condition of those types in which the change in altitude or direction is very rapid or the pitch of the airplane becomes very steep so that a crash is imminent. Other examples of a disaster alert may be those situations in which the route of the aircraft has changed beyond what may be expected for an in-flight error in position and is changed sufficient to indicate that an entirely new destination has been selected, as may occur with a hijacking or equipment failure. In the event a disaster alert is generated the emergency transmittal module is activated and signals are sent to additional ground stations so that a disaster team is alerted and immediate action may be taken for more detailed monitoring of the flight or other action to avert the disaster or to save the lives of those onboard.

### BRIEF DESCRIPTION OF THE SEVERAL VIEWS OF THE DRAWING(S)

FIG. 1 is a symbolic view of the aircraft and satellite systems for carrying out the present invention.

FIG. 2A is a block diagram schematic of the major components of the present invention.

FIG. 2B is a block diagram schematic of the components in the air relay module.

FIG. 3 is a block diagram schematic of an alternative embodiment of the present invention.

FIG. 4 is a schematic representation of the data transmission format.

FIGS. 5A and 5B are flow charts showing operation of the present invention according to various alternative embodiments.

### DETAILED DESCRIPTION OF THE INVENTION

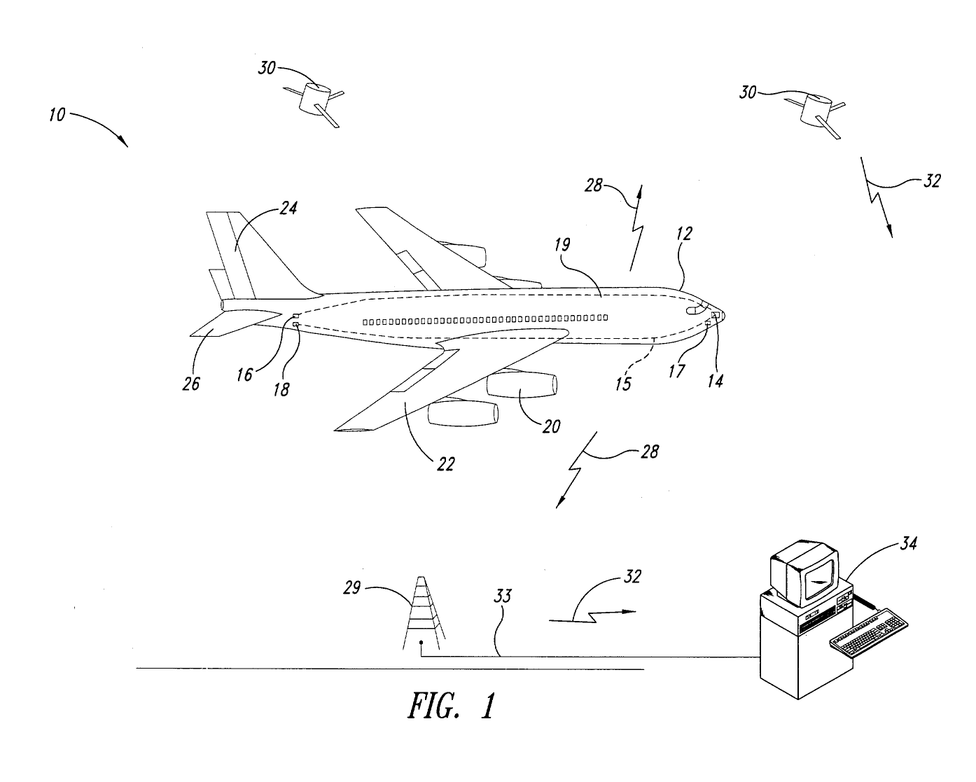

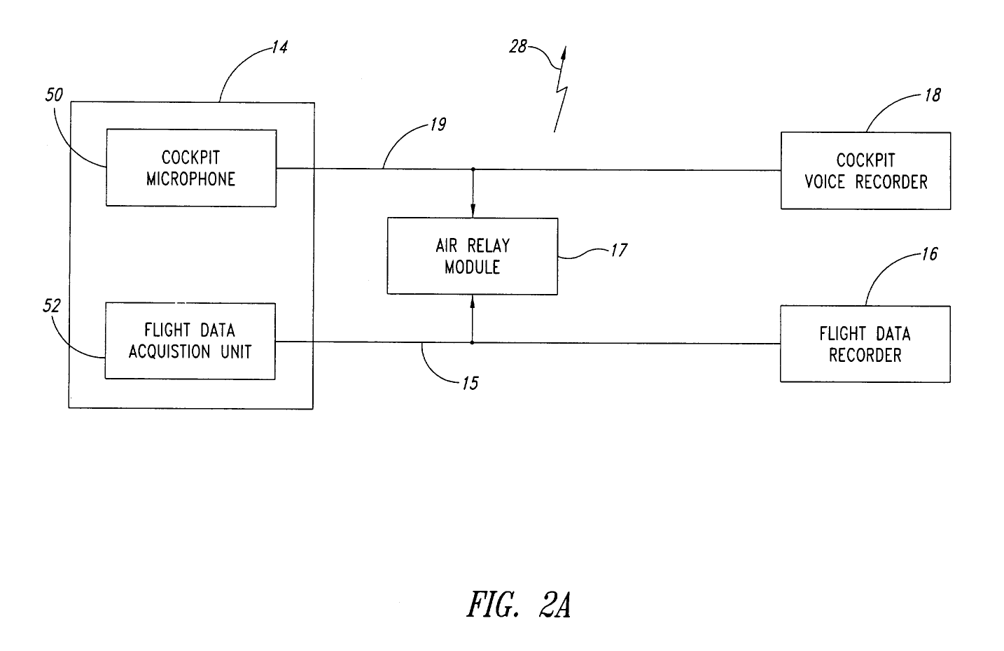

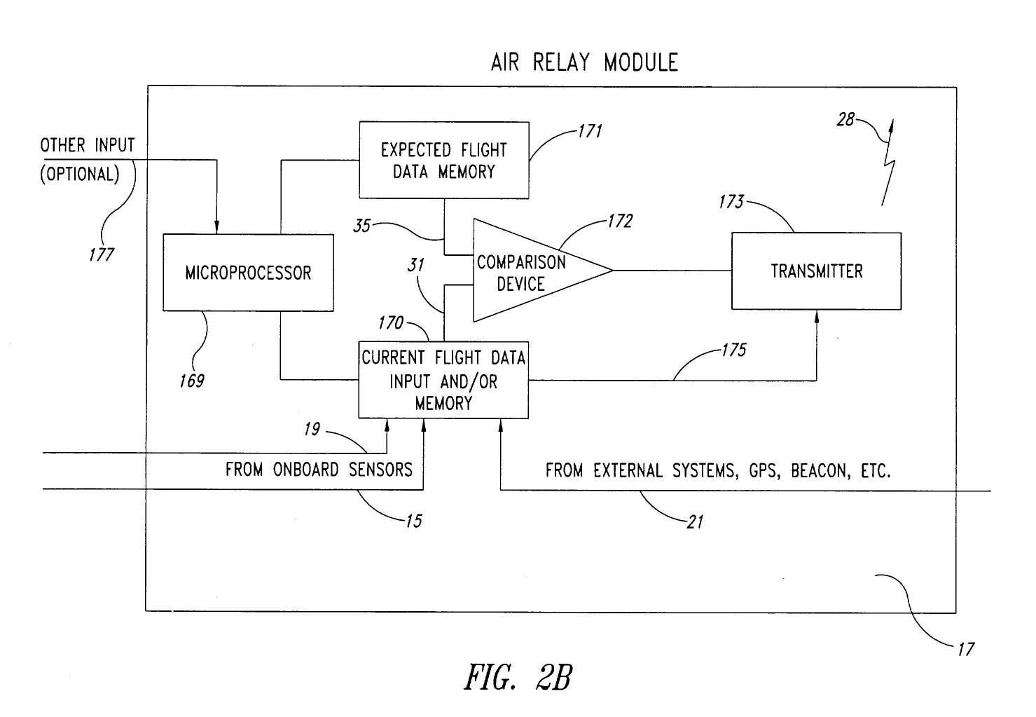

FIGS. 1 and 2A illustrates an aircraft 10 having a flight collection sensor unit 14 and an air relay module 17, and a first storage device 20 including a cockpit voice recorder 18 and a flight data recorder 16. The flight collection sensors 14 include a cockpit microphone 50 and a flight data acquisition unit 52 (see FIG. 2A). The cockpit voice recorder 18 is coupled to the cockpit microphone 50 via a transmission line 19 and a flight data recorder 16 is coupled to the flight data acquisition unit 52. The cockpit voice recorder 18 or the flight data recorder 16 could use magnetic tape or solid-state memory boards as storage media to record the actual flight data.

The aircraft 10 includes those features standard on all commercial airlines such as engines 20, wings 22, a rudder 24, a horizontal stabilizer 26 and other flight control surfaces. Many portions of the aircraft have flight control surfaces. For example, the flight control surface on a wing 22 includes such surfaces as flaps and ailerons. The flight control surfaces on the rudder 24 include the surface of the rudder as well as flight control surfaces on the horizontal stabilizer. The engine 20 in some embodiments also includes flight control surfaces, such as engine brakes or other members which may be deployed or retracted in order to change the flight conditions of the aircraft 10. Referring jointly to FIGS. 1 and 2A, the air relay module 17 of the aircraft 10 is equipped to evaluate the data collected by the flight collection sensor unit 14 as well as other information regarding the position of the aircraft and to transmit an alert signal 28 if certain criteria are satisfied. The alert signal 28 is sent to a location outside the aircraft via a radio transmission so that it is received at a different location. The air relay module 17 then transmits all the information which is received by the flight collection sensor unit 14 simultaneously with it being sent to the recorders. Thus, all sound picked up by the various microphones in the aircraft, such as the cockpit microphone, as well as the data acquired by the flight data acquisition units are transmitted to a different location simultaneously with them being sent for recording in the black boxes of the flight data recorder 16 and the cockpit voice recorder 18.

As can be seen in FIG. 1, the flight data on signal 28 can be sent to any appropriate transmission collection location. One acceptable collection location is a ground base radio receiver 29. This radio receiver 29 may be a cell tower used by standard cell phones, a satellite listening station, or any other appropriate ground-based radio receiver. Another acceptable mode of receiving the flight information of signal 28 are satellite receivers, such as used by satellite cell phones, satellite video and audio signals, or other satellites that are available for various communication transmissions. There are currently multiple satellite companies and numerous transmission frequencies and schemes operating around the world that provide 100% earth coverage. Thus, regardless of whether the aircraft is over land or over ocean, the signal 28 may be transmitted to a location outside the aircraft and the data collected. Accordingly, current communication channels exist which may gather and effectively transmit the data sent following an alert signal so that it may be communicated outside the aircraft while the aircraft remains in flight.

Once the data is received at the remote location, whether ground-based receiver 29, satellite receiver 30, or other communication equipment, the data is then transmitted to a ground-based repository 34, as shown in FIG. 1. For example, the ground-based receiver 29 may be connected by a hardwire LAN link 33 so as to provide a solid electrical connection to the ground-based repository 34. Alternatively, the data may be sent by radio transmission 32, whether from the ground-based receiver 29 or from the satellite system 30 so that it is received by the ground-based repository 34.

The ground-based repository 34 includes all of the hardware and software necessary for the acquisition, sorting, and storing of the flight sensor data instantaneously with it being collected. It includes hard disk drives for storing the data as well as microprocessors and computers to evaluate and sort the data according to any desired parameters. A display is also provided together with user interface, such as a keyboard and a mouse, so that personnel may view the data as desired, either simultaneously with it being received or at some later point in time when retrieval of the stored data is desired.

Advantageously, the ground-based repository 34 can have significantly more storage capacity than possible in any single aircraft or in multiple aircraft. At a relatively low cost, large amounts of data can be stored at the ground base repository 34. Further, as new storage and retrieval technology is invented, the ground-based repository 34 can be easily updated to include the new technology at a relatively low cost. Retrofitting an aircraft 10 with new black boxes having new data recording technologies is extremely expensive and time-consuming as compared to the updating of a ground-based repository 34. Thus, the ground-based repository 34 may be updated without taking the aircraft out of service or without affecting any of the aircraft electronic control systems.

In summary, as shown in FIGS. 1 and 2A, the information gathered from the flight collection sensor unit 14, such as the cockpit microphone 50 and the flight data acquisition unit 52 will be gathered and transferred via a transmission device utilizing commercially and privately available communication networks for capture and forwarding of the black box data to the central repository 34. The transmission can be provided using Internet protocol transmission or any other proven communication technologies for both voice and data information.

This information is then stored in a mainframe-based computer system housed in an acceptable location. For example, it may be housed at any major airport facility or at an FAA or other government or licensed partner data facility as part of the central database or distributed database. The information gathered will be stored by flight number, airline company, plane type, engine type, starting and destination times, etc. It can be sorted and stored by any of many acceptable parameters. The information in the database can then be easily and effectively and timely retrieved and used in a number of different ways. For example, immediate retrieval of the flight sensor data can be obtained in the event of an accident. Further, in the event of a mid-flight crisis or deviation from course, an alert can be provided to the FAA authorities so that the aircraft can be monitored, together with monitoring the data being transmitted by the flight data sensors. Thus, the FAA personnel, instead of merely having the voice communication with the pilot available, also will have available immediately the information from the flight data recorder, so there is a more complete understanding of the aircraft conditions and additional analysis can be carried out. A yet further advantage of having the flight data recorder information stored at a ground-based system is that preventive and predicted maintenance can be carried out. The data collected can, if desired, be sent to the various airlines or the aircraft manufacturer in order to review the operation and response of certain flight control surfaces. The data can be further analyzed in order to perform maintenance on the aircraft outside of what normally would be expected. Thus, the airline or the appropriate repair authorities will receive actual data while recorded while in flight, so the actual condition of the aircraft can be more accurately understood. Thus, maintenance can be carried out to ensure that disasters do not happen. A yet further advantage is that the data can be used for training of various personnel. Pilots, as well as air traffic controllers can view the data and understand conditions which occur in flight, and then be prepared to take corrective action in the event various disasters are transmitted from an aircraft while in flight.

It is known in the art today that the flight collection sensor unit 14 will collect a large amount of data regarding operation of the flight. In standard commercial aircraft today, such flight data information is collected at sensors and transmitted to the black boxes which are comprised of the cockpit voice recorder 18 and the flight data recorder 16. The flight collection sensor unit 14 is therefore the manager of the entire data and voice collection and recording process. It takes the information from the sensors and sends it on to the black boxes. In addition to the voice communications, the flight collection sensor unit 14 collects in the range of 30 to 100 different events according to standard operating procedures. These events include:

(1) Time;

(2) Pressure altitude;

(3) Indicated airspeed;

(4) Heading—primarily flight crew reference (if schedule, record discrete, true or magnetic);

(5) Normal acceleration (Vertical);

(6) Pitch attitude;

(7) Roll attitude;

(8) Manual radio transmitter keying, or CVR/DFDR synchronization reference;

(9) Thrust/power of each engine—primary flight crew reference;

(10) Autopilot engagement status;

(11) Longitudinal acceleration;

(12) Pitch control input;

(13) Lateral control input;

(14) Rudder pedal input;

(15) Primary pitch control surface position;

(16) Primary lateral control surface position;

(17) Primary yaw control surface position;

(18) Lateral acceleration;

(19) Pitch trim surface position or parameters of paragraph;

(20) Trailing edge flap or cockpit flap control selection;

(21) Leading edge flap or cockpit flap control selection;

(22) Each thrust reverser position (or equivalent for propeller

airplane);

(23) Ground spoiler position or speed brake selection;

(24) Outside or total air temperature;

(25) Automatic Flight Control System (AFCS) modes and engagement status, including autothrottle;

(26) Radio altitude (when an information source is installed);

(27) Localizer deviation, MLS Azimuth;

(28) Glideslope deviation, MLS Elevation;

(29) Marker beacon passage;

(30) Master warning;

(31) Air/ground sensor (primary airplane system reference nose or main gear);

(32) Angle of attack (when information source is installed);

(33) Hydraulic pressure low (each system);

(34) Ground speed (when an information source is installed);

(35) Ground proximity warning system;

(36) Landing gear position or landing gear cockpit control selection;

(37) Drift angle (when an information source is installed);

(38) Wind speed and direction (when an information source is installed)

(39) Latitude and longitude (when an information source is installed);

(40) Stick shaker/pusher (when an information source is installed);

(41) Windshear (when an information source is installed)

(42) Throttle/power lever position;

(43) Additional engine parameters;

(44) Traffic alert and collision avoidance system;

(45) DME 1 and 2 distances;

(46) Nav 1 and 2 selected frequency;

(47) Selected barometric setting (when information source is installed);

(48) Selected altitude (when information source is installed);

(49) Selected speed (when information source is installed);

(50) Selected mach (when information source is installed);

(51) Selected vertical speed (when information source is installed);

(52) Selected heading (when information source is installed);

(53) Selected flight path (when information source is installed);

(54) Selected decision height (when information source is installed);

(55) EFIS display format;

(56) Multi-function/engine/alerts display format;

(57) Thrust command (when information source is installed);.

(58) Thrust target (when information source is installed);

(59) Fuel quantities in CG trim tank (when information source is installed);

(60) Primary Navigation System Reference;

(61) Icing (when information source is installed);

(62) Engine warning each engine vibration (when information source is installed);

(63) Engine warning each engine over temp. (when information source is installed);

(64) Engine warning each engine oil pressure low (when information source is installed);

(65) Engine warning each engine over speed (when information source is installed);

(66) Yaw trim surface position;

(67) Roil trim surface position;

(68) Brake pressure (selected system);

(69) Brake pedal application (left and right);

(70) Yaw or sideslip angle (when information source is installed);

(71) Engine bleed valve position (when information source is installed);

(72) De-icing or anti-icing system selection (when information source is installed);

(73) Computer center of gravity (when information source is installed);

(74) AC electrical bus status;

(75) DC electrical bus status;

(76) APU bleed valve position (when information source is installed);

(77) Hydraulic pressure (each system);

(78) Loss of cabin pressure;

(79) Computer failure;

(80) Heads-up display (when information source is installed);

(81) Para-visual display (when information source is installed);

(82) Cockpit trim control input position—pitch;

(83) Cockpit trim control input position—roll;

(84) Cockpit trim control input position—yaw;

(85) Trailing edge flap and cockpit flap control position;

(86) Leading edge flap and cockpit flap control position;

(87) Ground spoiler position and speed brake selection; and

(88) All cockpit flight control input forces (control wheel, control column, rudder pedal).

The above listing of 88 events is one set of events which may be collected during standard operating flight conditions for some types of aircraft. Of course, some aircraft may collect additional events beyond those shown or may collect only a subset of those events shown. Under standard operating conditions, the events are collected by the data acquisition unit and transmitted via transmission lines 15 and 19 to the cockpit voice recorder 18 and flight data recorder 16. These recorders store the information as it is received. Since the recorders have a limited amount of storage time, as new data is received the existing data is written over so that only the most recent block of time, such as the most recent half hour or one hour of the recorded data remains in the recorders.

Beside the cockpit microphone 50 and the flight data acquisition unit 52, the flight collection sensor unit 14 could further comprise a set of audio-video cameras. The audio-video cameras could be small pin size with high resolution and sensitivity, and be placed strategically through out the airplane cabin and cockpit to provide 100% coverage. Those cameras will be automatically activated by some criteria conditions, such as an alert event is happened, or be manually triggered by an authorized crewmember. The captured audio or video data from the audio-video cameras then could be stored in the air relay module 17 and be transmitted thereby to provide valuable data to ground support personnel.

As mentioned, the air relay module 17 of the aircraft 10 is equipped to evaluate the data collected by the flight collection sensor unit 14 as well as other information regarding the position of the aircraft and to transmit an radio transmission 28 if certain criteria are satisfied. If the air relay module 17 is activated, the radio transmission 28 is sent to a satellite system 30 or other communication system as shown in FIG. 1. The air relay module 17 sends the radio transmission signal 28 based on a triggering event as described later in detail herein. The satellite system 30 receives the transmitted data and retransmits it to the ground-based repository 34 which contains a storage system at a remote location, such as the FAA regional office or some other acceptable location for storing flight data.

The air relay module 17 could further comprise a second storage device 171, a current flight input circuit 170, a comparison device 172, and an alert and data transmitter 173, as shown in FIG. 2B. The second storage device 171 previously stores the expected flight parameters or data input before the aircraft takes off. These expected flight parameters include items such as the flight number, the departure airport, the destination airport, the route to be followed, the beacon code, flight path of the aircraft according to a previously provided flight plan, as well as other expected flight parameters, such as acceptable pitch angle, turning angle, roll angle, etc.

The Air Relay Module 17 (ARM) contains a mini microprocessor preferably having storage devices 170 and 171 in the same computer memory. The input 170 will gather FDAU and Cockpit Voice Recording information on lines 15 and 19 concurrently as it is transmitted to the “Black Boxes.” This will be accomplished with the modification of the communication transmission cable to allow for a parallel transmission of the data. The mini microprocessor may include a 1.2-GHz/800-MHz Pentium III-M processor and a 40 GB hard drive. The microprocessor will operate on a standard operating system and will run a written software application in MS SQL or other FAA approved software language. The software application may be specific for each model and manufacture of aircraft if desired. If it is specific, it can more easily support the level of data being captured for the FDR and CVRs that differ by aircraft type and manufacture. For each event recorded, a software application will be run containing a set of operating parameters for that particular aircraft and that event. For example, the performance characteristics of the aircraft from the flight manual for that aircraft can be stored in memory to set a standard for aircraft performance and to create the thresholds.

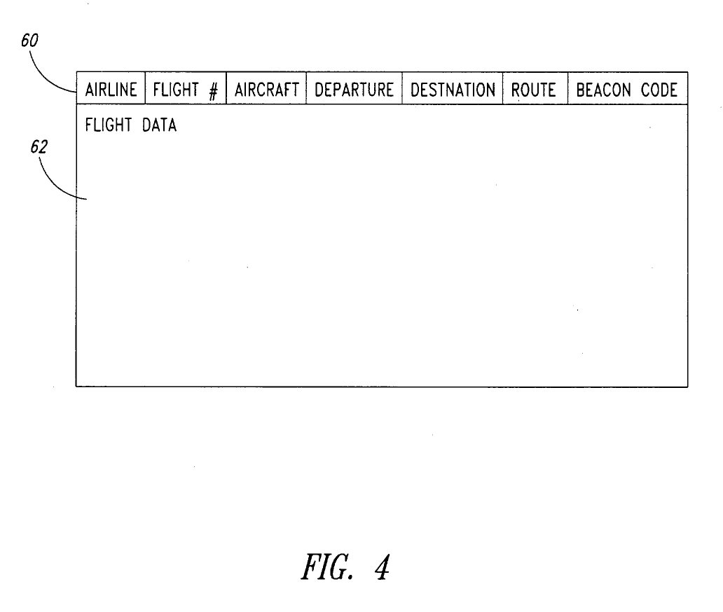

Today, during the preflight preparation the aircraft's information to identify the flight is entered into the FAA systems. The information about a flight consists of the airline's name and flight number, type of aircraft and equipment, intended airspeed and cruising altitude, route of flight (departure airport, centers that will be crossed, and destination airport), and Beacon code of the aircraft (each aircraft has a unique code assigned to it). At the same time it is provided to the FAA systems, it is automatically entered into the expect flight data storage memory 171. Thus the computer will have stored therein the altitude of the airport from which it is taking off, the temperature at time of takeoff and other local environmental factors that affect the aircraft's safe takeoff flight parameters. Data about-the aircraft can be formatted as the header of information as shown in FIG. 4. The expected flight data is provided on bus 35 to a comparison circuit 172. During flight, the current flight data is provided from the input circuit 170 on bus 31 also to the comparison circuit 172. Further, the current flight input circuit 170 may receive data from external systems, such as a GPS system, an on-ground beacon system, or other external source which provides the precise position of the aircraft and other travel information measured from an external source. This external feed source 21 is an alternative embodiment, and may not be provided in all embodiments, however, in those embodiments in which it is provided substantial advantages are gained in being able to more accurately track the exact position of the aircraft and send alert notices based not only on changes in flight operating parameters but also on an overall change in the actual location of the aircraft from an expected position. All the data, whether from onboard sensors as received on lines 15 and 19 or from an external system on line 21 is provided to the input circuit 170 and thereafter provided on bus 31 to the comparison circuit 172.

As previously noted, preferably the entire air relay module 17 is on a mini microprocessor with a motherboard and a hard drive. Thus, the comparison circuit may be implemented in software or a combination of software and hardware as contained within the microprocessor. Thus, the elements of the air relay module can be implemented in software on a microprocessor system, in firmware stored in embedded code, or some other combination thereof. The comparison circuit 172 would therefore be a hardware or software module which is capable of comparing a large number of current flight parameters simultaneously as they are input with a large number of expected flight parameters as previously stored and received on bus 35. The data on buses 31 and 35 would therefore be compared using the appropriate comparison software and decision tree for simultaneously comparing large amounts of data to each other and outputting a response if the comparison yields a difference which exceeds a first threshold, as will now be explained.

When a difference between the expected flight data and current flight data is sensed at the comparison circuit 172 that is outside of normal operational parameters by a threshold value for one or more particular parameters, an immediate transmission, starting with the header then followed by the data that has been gathered and continues to be gathered will be sent out via the Precise Positioning System (PPS), see FIG. 4. This condition initiates the system into full transmission operational mode via transmitter 173 allowing for a continuous feed of ARM 17 data. The current flight data can be provided on bus 175 directly to the transmitter 173 and it is not necessary for it to go through the comparison circuit 172. Once the comparison circuit 172 activates the transmitter, then the data is transmitted directly via the input circuit 170 to the transmitter 173 in a preferred embodiment.

Among the data which is collected and transmitted can be external data on line 21, such as from a GPS system. The GPS Operational Constellation consists of 24 satellites that orbit the earth in 12 hours. The satellite orbits-repeat almost the same ground track (as the earth turns beneath them) once each day. The orbit altitude is such that the satellites repeat the same track and configuration over any point approximately each 24 hours (4 minutes earlier each day). There are six orbital planes (with nominally four SVs in each), equally spaced (60 degrees apart), and included at about fifty-five degrees with respect to the equatorial plane. This constellation provides between five and eight SVs visible from any point on the earth.

The air relay module 17 will preferably run on the PPS system which is limited to military/government use only. PPS is operated by the DOD under secure/encrypted format ensuring the data being transmitted is protected. GPS Positioning Services Specified In The Federal Radio navigation Plan Precise Positioning Service (PPS) Authorizes users with cryptographic equipment and keys and specially equipped receivers use the Precise Positioning System. U.S. and Allied military, certain U.S. Government agencies, and selected civil users specifically approved by the U.S. Government, can use the PPS. PPS Predictable Accuracy 22 meter Horizontal accuracy 27.7 meter vertical accuracy 200 nanosecond time (UTC) accuracy.

The SVs transmit two microwave carrier signals. The L1 frequency (1575.42 MHz) carries the navigation message and the SOS code signals. The L2 frequency (1227.60 MHz) is used to measure the ionospheric delay by PPS equipped receivers. Three binary codes shift the L1 and/or L2 carrier phase. The C/A Code (Coarse Acquisition) modulates the L1 carrier phase. The C/A code is a repeating 1 MHz Pseudo Random Noise (PRN) Code. This noise-like code modulates the L1 carrier signal, “spreading” the spectrum over a 1 MHz bandwidth. The C/A code repeats every 1023 bits (one millisecond). There is a different C/A code PRN for each SV. GPS satellites are often identified by their PRN number, the unique identifier for each pseudo-random-noise code. The C/A code that modulates the L1 carrier is the basis for the civil SPS. The P-Code (Precise) modulates both the L1 and L2 carrier phases. The P-Code is a very long (seven days) 10 MHz PRN code. In the Anti-Spoofing (AS) mode of operation, the P-Code is encrypted into the Y-Code. The encrypted Y-Code requires a classified AS Module for each receiver channel and is for use only by authorized users with cryptographic keys. The P (Y)-Code is the basis for the PPS. The Navigation Message also modulates the L1-C/A code signal. The Navigation Message is a 50 Hz signal consisting of data bits that describe the GPS satellite orbits, clock corrections, and other system parameters. The CVR information will be transmitted under the same guidelines. The data will be transmitted to a secure computer running at a FAA or FAA approved data center known as the Emergency Action Response Center 34 or (EAR).

The Air Relay Module 17 inputs 19 and 15 will also have a “hot key” that allows the pilots or authorized crewmembers to initiate and start the communication and transmission of data to the satellite network. By depressing the hot key on the ARM 17 component of the system, the pilots or authorized crewmembers alert the EAR 34 of a possible threat or other emergency condition of the flight.

An optional video feed will be available. The video will consist of small pin size video cameras with high resolution and low light sensitivity features that allow the cameras to function under low-level light conditions. The cameras will be placed (depending on the aircraft and type) strategically throughout the airplane cabin and cockpit to provide 100% coverage and will have audio capabilities. The cameras will be of mini pinhole in size and be equipped with wide-angle lenses for total aircraft coverage. The cameras will be activated by an out-of-tolerance conditions, or an event situation by airline-authorized crewmembers. A quad processor will be used to allow for multiple recording and for viewing a simultaneous time based digital recording of all the cameras and the data will be captured to disc. The disc will be housed in the ARM 17 microprocessor unit 170. The cameras will allow for a whole new level of security and safety within an aircraft. They can be used in medical emergencies to aid the aircraft crew or any other threat conditions to provide valuable data to ground support personnel inn extreme situations they can be used in concert with Biometric technology which is the use of digital technologies that establish the identity of a person based upon unique physical characteristics such as a fingerprint, a voice, the iris of an eye or a face. Biometrics is based on an algorithm that allows computers to do “pattern matching,” which characterizes and records patterns of the human body. It measures deviations and creates a map of the face so that it can identify a person analytically.

As technology and capacity is increased in the Precise Positioning System (PPS) or other approved satellite system(s) the ability for full voice, data, and voice continuous transmissions may be enabled with a modification to the ARM software component. The modifications consist of programmable changes to the software that allows for a continuous feed and transmission of flight data and optional video.

The ARM unit 17 will be in an aluminum housing with high temperature insulation and a stainless steel or titanium shell. The ARM 17 will be powered by one of two power generators that draw their power from the aircraft's engines. One generator is a 28-volt DC power source, and the other is a 115-volt, 400-hertz (Hz) AC power source. These are the same power sources as the Black Boxes, and are standard aircraft power supplies. The power and data cable connections are thus compatible in all respects with the current aircraft systems. The ARM 17 unit will be equipped with a battery backup in the event of a total power failure.

Returning now to a description of the system following takeoff. As the flight progresses, all of the actual flight parameters are monitored. The comparison device 172 continues to compare the actual flight data to the expected flight parameters to monitor whether the aircraft flies on the expected flight route and within the expected operating parameters. As long as the aircraft continues on the expected route and within the expected operating parameters, no transmission is sent from the air relay module to the ground.

If at any time during the flight the aircraft is out off the expected route by a threshold or any of the actual flight parameters is not within a threshold value of the expected operating range, an alert event occurs and then the air relay module 17 will instantaneously begin to transmit the current flight information to the ground-based repository 34 which is the same data being sent to the cockpit voice recorder and the flight data recorder. That is, if the actual flight data is different from the expected flight parameters by a first threshold amount, an alert event is happened and the comparison circuit 172 will generate an alert signal. The transmitter is activated by the alert event to cause the air relay module 17 to instantaneously transmit the current flight information of signal 28 for storage on the ground.

An alert event may be any number of potential events. It could be an alert event if the aircraft has strayed from its expected flight route or path by greater than the threshold distance. For example, the expected flight path or route could be stored in the second storage device 171. After taking off, the comparison device 172 compares the expected route to the actual flight route detected from Global Position System (GPS) or Precise Position System (PPS) in the aircraft. An alert circuit with the comparison device 172 generates the alert signal if the difference between the expected flight route and the actual flight route is over the first threshold amount, such as 5 miles or other predetermined range.

The threshold will be set by the aircraft maker, the airline or the FAA. It is software programmable to different values at any time before or after the system is installed. Further, it will be changed automatically by the microprocessor 169 based on data input to the system. For example, if the aircraft is taking off from an airport at a high altitude and on a hot day, such as Mexico City in the middle of the summer, acceptable takeoff conditions will vary dramatically based on a takeoff from a low altitude on a colder day. Thus, the local environmental data will be stored into the current flight data input in memory 170 for evaluation by the microprocessor 169. It will be analyzed together with the flight performance characteristics for that particular aircraft, such as those found in the flight manual which have been stored in memory 171. Thus, relative environmental factors including such things as aircraft weight, wind speed, runway length, etc., will be input on either lines 15, 19 or 21 into the current flight data memory 170. The microprocessor using the data in memories 170 and 171 will create a profile for acceptable takeoff parameters and create thresholds based on such acceptable parameters.

In one embodiment, the microprocessor can be programmed to vary the threshold for a particular parameter as the conditions change and the aircraft changes its desired flying characteristics based on the flight plan. Some thresholds, such as rate of climb, pitch angle, etc., are dependent on the altitude, temperature, aircraft weight, and wind speed, as some examples. A flight parameter that may be acceptable at takeoff is not acceptable and would be considered an unsafe operation if the aircraft were at a cruising altitude of over 30,000 feet, and vice versa. Since the memory 171 has stored therein the data from the flight manual, and the microprocessor constantly received new aircraft data from the memory 170 and from other sources, it can change the thresholds for various parameters while in flight, making some more strict and some less strict. For example, while the threshold deviation for distance from flight path is set at 5 miles, it can be easily modified by a software download to be 1 mile, 10 miles, or some other value.

Other alert events may be that the aircraft has experienced a very sharp turn, excessive pitch, angle, or roll beyond a normal expected operating condition of the aircraft, or an unexpected change in position of one of the flight control surfaces. For example, it could be an alert event if the change in rate of climb or rate of descent is outside a threshold value. For example, if a rate of climb exceeds some established rate, such as 5000 feet per minute, or a rate of descent above a threshold, such as 3000 feet per minute, the alert signal is generated. Further is if the pitch of aircraft is more than a first threshold amount, such as 12°, a first alert signal is sent. If the pitch of the aircraft changes greater than a second stored threshold, such as 17°, an emergency signal will activate the air relay module 17 to transmit the current flight information or data.

The flight data transmitting and storing method has two possible triggering states to transmit actual flight data, according to one embodiment. The first triggering state is an alert event and the second triggering state is an emergency condition.

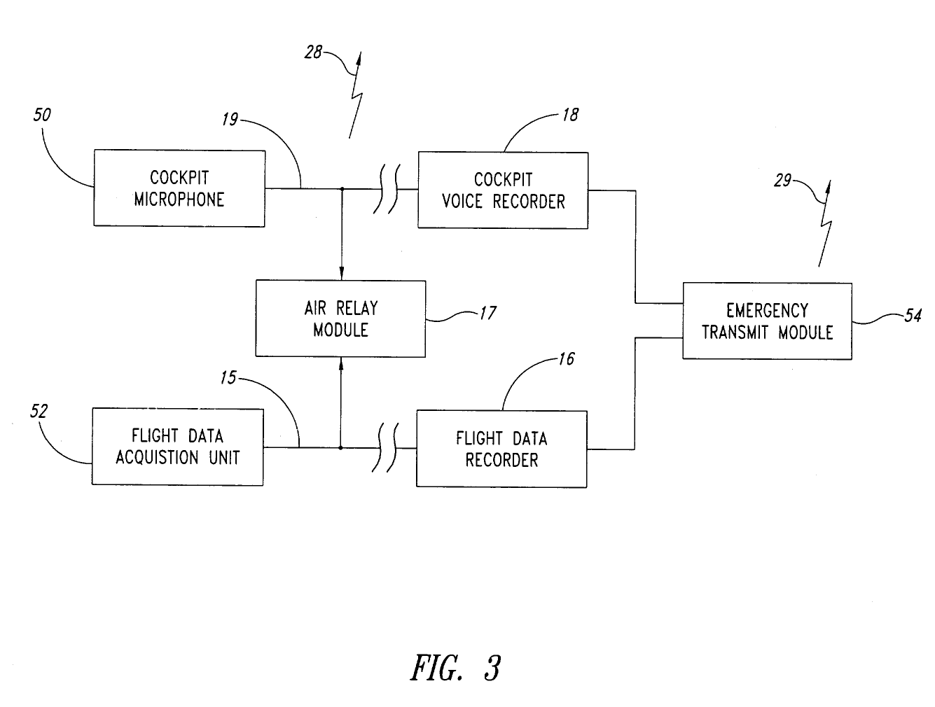

In an alternative embodiment, the aircraft 10 further includes a disaster transmit module 54 as shown in FIG. 3. The disaster transmit module 54 is coupled to the cockpit voice recorder 18 and the flight data recorder 16. Moreover, the input/output interface of disaster transmit module is compatible with interfaces of the cockpit voice recorder 18 and the flight data recorder 16, therefore, it is easy to install, maintain, even upgrade the disaster transmit module 54 in any existed aircraft.

The disaster transmit module 54 is activated by an emergency condition to instantaneously transmit the flight data previously stored in the cockpit voice recorder 18 and the flight data recorder 16. Such emergency condition could be the situation that the deviation between the actual flight parameters and the expected flight parameters is over a second threshold amount which is greater than the first threshold amount in the alert event situation above-mentioned. For example, if the difference between the actual flight route and the expected flight route is over the second threshold amount, for example 10 miles or other predetermined range, which is greater than the first threshold, such as 5 miles in the alert event situation, the disaster transmit module 54 is activated to instantaneously transmit the flight data previously stored in the cockpit voice recorder 18 and the flight data recorder 16 via the communication system to the ground-based repository 34. Furthermore, before the transmission of the flight data previously stored, the disaster transmit module 54 could transmit an emergency or disaster signal to an emergency action center or ground control center which could response such emergency attention signal by noticing FAA or other responsible authority, and/or by operating necessary emergency actions.

Alternatively, the emergency condition can also be triggered by authorized crewmembers. For example, the cockpit will include an emergency switch that the crew may activate in order to initiate the emergency condition. This emergency switch could be an alert button triggered by the crewmember, or could be a voice-activated switch triggered upon receiving a predetermined verbal input from the authorized crewmember. After the emergency is triggered by the authorized crewmembers, the disaster transmit module 54 begins to transmit the previously stored flight information or data to the communication network for subsequent storage.

In order to minimize the transmission time, the flight data previously stored is compressed before the transmission by the disaster transmit module 54. If the disaster transmit module 54 is activated, all the data previously stored in flight data recorder 16 and cockpit voice recorder 18 is downloaded rapidly in to the disaster transmit module 54 and compressed for immediately transmission. The entire content of the storage data within the recorders is thereafter immediately transmitted via satellite network 30 or other communication network to the ground-based repository 34. Since such transmission is done of compressed data, the entire contents of the data can be transmitted in a short period of time, for example, less than five minutes, or in some instances less than one minute, so that in addition to capturing the instantaneous flight parameters, the previous set of stored data has also been transmitted for ground storage and later analysis. Especially, when the solid-sate memory boards are used as storage media in the flight data recorder 16 and cockpit voice recorder 18, the disaster transmit module 54 could easily and promptly download important flight data stored in the solid-state memory board through the specific memory address while still recording new data. Thus, the transmitting and recording can be done concurrently.

The alert event may be activated by an unexpected route location or sudden changes in the aircraft beyond the expected flight parameters. In those situations in which the changes in the aircraft are beyond a second threshold or a serious deviation and become a potential crash, the disaster alert or the emergency condition may be triggered. A disaster alert would be a condition of those types in which the change in altitude or direction is very rapid or the pitch of the airplane becomes very steep so that a crash is imminent. For example, if the pitch of the aircraft does not exceed the pitch used during taking off or is not steeper than for a normal landing, the alert event is not activated. On the other hand, if the pitch is over that used during a takeoff but less than a set amount or a second threshold amount, the alert event is activated, but the disaster alert is not activated. If the rate is over greater than the set amount, the disaster alert is triggered. Of course, these values are also easily changed by software programming. Similar two triggering states are applied to monitor other flight parameters. Of course, the thresholds are set based on expected operating conditions for that particular aircraft in its current flight environment.

Other examples of the alert event or the disaster alert may be those situations in which the route of the aircraft has changed beyond what may be expected for an in-flight error in position and is changed sufficient to indicate that an entirely new destination has been selected, as may occur with a hijacking or equipment failure. For example, if the deviation of the route is under 5 miles or a first threshold amount, the alert event is not triggered. After the deviation of the route is over 5 miles but still under 10 miles or a second threshold amount, the alert event will be triggered. However, in case the deviation is over 10 miles, the disaster alert is triggered. The GPS system in the aircraft could help to calculate the deviation of the route. In the event a disaster alert is generated, a disaster team is alerted and immediate action may be taken for more detailed monitoring of the flight or other action to avert the disaster or to save the lives of those onboard.

Moreover, an alert event can be alternatively triggered by authorized crewmembers. For example, the cockpit will include an alert switch that the crew may activate the alert switch to initiate an alert event. The alert switch could be an alert button such that after the crewmember triggers the alert button, the alert signal is initiated and then the air relay module 17 begins to transmit the current flight information or data to the communication network for subsequent storage. Furthermore, the alert switch could be a voice-activated switch which generates the alert signal upon receiving a predetermined verbal input from the authorized crewmember.

The air relay module 17 is coupled between the flight collection sensor unit 14 and the first storage device 20, and connected to the transmission lines 15 and 19. The air relay module 17 could be easily installed into the aircraft because its input/output interfaces, such as its connecting cables or outlets, are compatible with the transmission lines 15, 19, and with interfaces of the flight collection sensor unit 14, the cockpit voice recorder 18 or the flight data recorder 16 in the existed aircraft. Therefore, it is not necessary to modify the interface of the existed devices in the aircraft 10 to accommodate the air relay module 17, and the installation of such air relay module 17 is not a time-consuming task. Also, it is convenient to upgrade the air relay module 17 in the aircraft 10 in case there is new technology in the near future enhancing the ability in the air relay module 17.

Shown in FIG. 4 is a schematic representation of the data transmission format. Since there could be many aircraft in the sky at the same time, a header will be affixed to the transmitted flight data of each aircraft in order to distinguish the flight data transmitted from different aircrafts, and furthermore, to provide sufficient information of each aircraft to the ground-based repository 34. The data transmission format includes the header 60 and the actually flight data 62. The header 60 could include any flight parameter which is required to be entered into the FAA system to identify the flight, such as the airline, flight number, the departure airport, the destination airport, the expected route to be followed, and/or the beacon code. Those flight parameters could be stored in the air relay module 17 and/or disaster transmit module 54 during the preflight preparation. In case there is an alert event or an emergency condition, an immediate transmission, starting with the header 60, of the actually flight data 62 will be sent by the air relay module 17 or the disaster transmit module 54. The flight data 62 with the header 60 gathered by the ground-based repository 34 then could be stored by flight number, airline company, departure, destination, and beacon code, etc. and therefore the flight data stored in the ground-based repository 34 can then be easily and effectively and timely retrieved and used in a number of different ways.

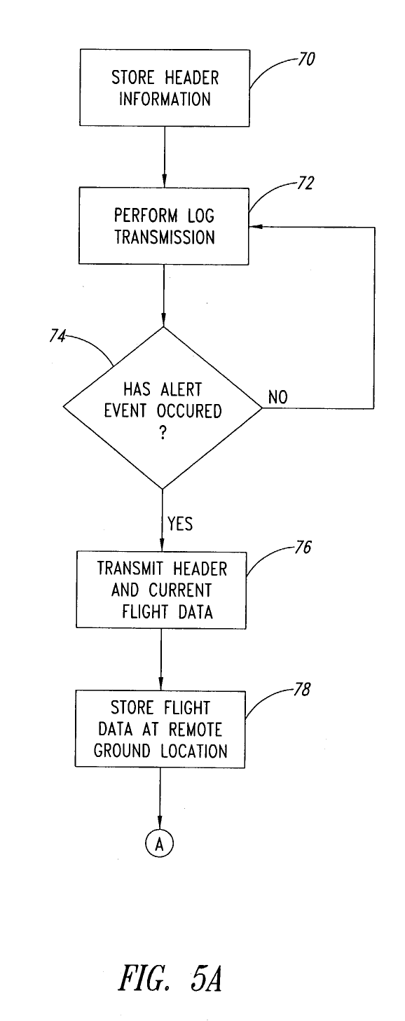

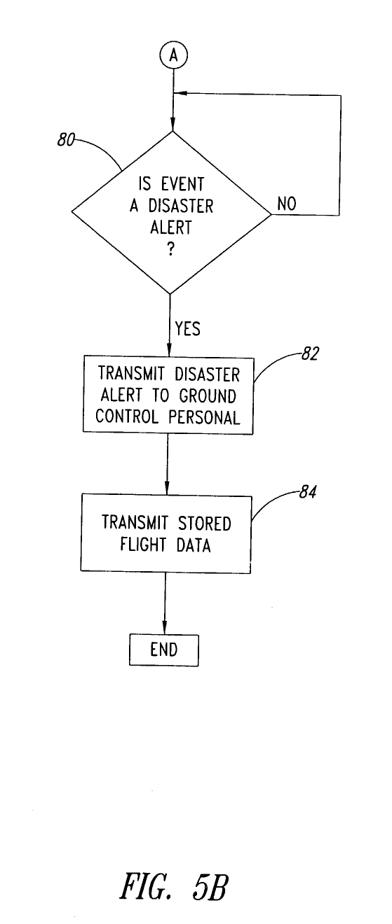

Referring to FIGS. 5A and 5B, the header information, including flight number, the departure airport, the destination airport, the expected route to be followed, and/or the beacon code, is stored in the aircraft shown in block 70. After the aircraft takes off, the actual flight data is regularly detected, collected, and may be stored in the aircraft input circuit 170, as shown in step 72. During the flight, the actual flight data is constantly checked to determine whether the alert event is happened, as shown in block 74. If the alert event is happened, the stored header and the current flight data detected are transmitted to and stored at the central data repository, as shown in block 76 and 78. On the other hand, if the alert event was not happened, the actual flight data will continuously be monitored to decide whether the alert event is happened.

Once a conditions is triggered, the Emergency Action Response Center 34 of EAR will be activated. The EAR 34 will house the computer hardware, software, and support. The EAR 34 will be a fully operational facility that contains built-in hardware redundancy, dynamic system domains, dynamic reconfiguration, hot CPU upgrades, online upgrades, concurrent maintenance, end-to-end ECC protection, redundant network connections, redundant storage connections, kernel hot patching, hardened operating system kernel, live operating system upgrades, journaling file system, hardened I/O drivers, and cluster support. Storage of the data will be provided through a Storage Area Network or SAN. The SAN will have: 99.999% availability, no single point of failure (fully-redundant fiber channel infrastructure), fiber channel SAN connectivity and performance, RAID 0+1 with data mirrored across two storage units. The backup capabilities will consist of Mirroring. Mirroring provides a mirror back-up of the data and makes it available to another other applications running on the primary or a secondary host eliminating lost or corrupt data.

The EAR 34 could be fully automated but will likely be staffed 24×7 by EAR members divided into the same 21 zones or centers controlled currently by the FAA plus zones for international locations as they come on-line. When the EAR 34 receives a notification of an out of tolerance fault condition from a flight, the EAR 34 will immediate notify the FM Flight Operations Center. The FM Flight Operations Center will contact the flight and determine the next course of action. Once the condition has been secured, the FAA Flight Operations turns the communications back to the EAR 34 and the EAR deactivates the transmissions. The ARM 17 will return to standard operating mode until a new fault condition is encountered.

The communications between the EAR 34 and FM Flight Operations will operate via a mail alert or incident alert messaging tool that allows for immediate zero latency communications. The mail or messaging tool will send an incident reportnotification directly to FAA Flight Operations and include an acknowledge of receipt of message returned to the EAR.

Information related to the CVR's recordings are treated differently than the other factual information obtained in an accident or incident investigation. Due to the highly sensitive nature of the verbal communications inside the cockpit, Congress has required that the Safety Board not release any part of a CVR tape recording. Because of this sensitivity, a high degree of security is provided for the CVR tape and its transcript. The content and timing of release of the written transcript are strictly regulated: under federal law, transcripts of pertinent portions of cockpit voice recordings are released at a Safety Board public hearing on the accident or, if no hearing is held, when a majority of the factual reports are made public. Due to these requirements strict security controls of CVR information will be incorporated into the EAR environment prohibiting the access or release of data without proper approval. Encryption incorporated in the PPS system supports this level of security of the data.

The ability to store retrieve and utilized historical data by airlines name and flight number, type of aircraft and equipment, intended airspeed and cruising altitude, route of flight departure airport, beacon towers that were passed-over and destination airport will be achieved and available based on authorization by the FAA and or other controlling parties. The information will be housed in the EAR 34 facility. A series of applications to support the gathering, storing, communicating and securing of ARM data will operate on computer hardware as outlined above. The applications will be written in FAA approved software languages and support FAA standard operating procedures (SOP) and design standards. The data will be managed under FAA SOP guidelines.

After entering into the alert event, the method will also constantly check whether an emergency condition or an disaster event is happened, as shown in block 80 in FIG. 5B. If the emergency condition or a disaster alert has happened, a disaster alert is promptly transmitted to ground control center or an emergency action center as shown in block 82, such that the ground control center or an emergency action center could immediately notice FAA or other responsible authority, and/or operate necessary emergency actions. Furthermore, after the disaster alert is transmitted, the stored flight data is immediately transmitted as shown in block 84. In order to facilitate the transmission capacity, all the transmitted flight data which is previously stored in flight data recorder 16 and cockpit voice recorder 18 could be compressed for immediately transmission such that the entire contents of the data can be transmitted in a short period of time. On the other hand, if the disaster event or the emergency condition has not yet happened, the method will constantly monitor whether such disaster event or emergency condition has happened.

Once the system has become well accepted and proven operational, it may be possible to no longer use on-board black box recorders. Rather, using a large memory bank in the ground station 34, the data can be stored only on the ground and the black boxes, being redundant systems, are no longer used. Thus, rather than the ARM 17 being the redundant system as taught in one embodiment of the present invention, the black boxes become the redundant system and they eventually are no longer installed on certain aircraft.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A flight data transmitting and storing system comprising:
an aircraft;
a flight monitoring system for gathering flight data containing information regarding the condition of flying parameters of the aircraft;
an alert sensing circuit for generating an alert signal based on a selected condition occurring within the flying parameters;
an on-board transmitter for transmitting the data via a radio signal from the aircraft to a ground-based data repository for storing the data on the ground.

2. The flight data transmitting and storing system of claim 1 wherein the flight data are sent in Internet Protocol (IP) format.

3. The flight data transmitting and storing system of claim 1 wherein the flight data is relayed to a central data repository maintained by a U.S. governmental agency.

4. The flight data transmitting and storing system of claim 1 wherein the selected condition is a deviation of the flight path of a previously filed flight plan.

5. The flight data transmitting and storing system of claim 1 wherein the selected condition is the aircraft pitch being greater than a threshold amount.

6. The flight data transmitting and storing system of claim 1 wherein the selected flight condition is a change in altitude above a threshold amount in shorter than a threshold time.

7. A flight data acquiring and transmitting apparatus comprising:
a fixed wing aircraft;
an acquisition device detecting a set of flight data of the aircraft;
a first storage device coupled to the acquisition device for storing the set of flight data; and
a transmission device transmitting the set of flight data outside the aircraft upon the occurrence of a triggering event.

8. The flight data acquiring and transmitting apparatus of claim 7 wherein the acquisition device comprises:
a cockpit microphone in the cockpit of the aircraft detecting the first set of flight data; and
a flight data acquisition unit detecting the second set of flight data.

9. The flight data acquiring and transmitting apparatus in claim 7 wherein the first storage device comprises:
a cockpit voice recorder storing the first set of flight data; and
a flight data recorder storing the second set of flight data.

10. The flight data acquiring and transmitting apparatus of claim 7 wherein the transmission device includes:
a second storage device having stored therein a plurality of expected flight data;
a comparison device for comparing the actual flight data to the expected flight data;
an alert device for generating an alert signal if the actual flight data is different from the expected flight data by a first threshold amount.

11. The flight data acquiring and transmitting apparatus of claim 10 wherein the expected flight data includes a flight path of the aircraft according to a previously provided flight plan.

12. The flight data acquiring and transmitting apparatus of claim 10, further including:
a switch positioned for activation by a crewmember to generate said alert signal in response to the switch being activated.

13. The flight data acquiring and transmitting apparatus of claim 8, further including:
a disaster signal device for generating a disaster signal if the actual flight data is different from the expected flight data of a second threshold.

14. The flight data acquiring and transmitting apparatus of claim 12 wherein the switch is a voice activated switch that is activated upon receiving a predetermined verbal input.

15. The flight data acquiring and transmitting apparatus in claim 7 wherein the acquisition device further comprises a set of audio-video cameras which is activated by a predetermined condition to detect a second set of flight data, and the second set of flight data being transmitted by the transmission device.

16. The flight data acquiring and transmitting apparatus in claim 7 wherein the transmission device comprises:
an air relay module coupled between the acquisition device and the storage device;
an alert sensor within the air relay module which is activated by the triggering event alert to cause the transmission device to transmit the set of flight data detected by the acquisition device.

17. The flight data acquiring and transmitting apparatus in claim 7 wherein the transmission device further comprises:
a disaster transmit module coupled to the storage device, the disaster transmit module being activated by an emergency condition to instantaneously transmit the set of flight data previously stored in the storage device.

18. The flight data acquiring and transmitting apparatus in claim 17 wherein the set of flight data transmitted by the disaster transmit module is compressed before the transmission and the compressed flight data transmitted is in a predetermined communication format including a set of flight parameters of the aircraft which were stored in the disaster transmit module prior to the aircraft taking off from the ground.

19. The flight data acquiring and transmitting apparatus in claim 17 wherein the disaster transmit module further transmits an emergency attention signal to an emergency action center before the compressed flight data is transmitted.

20. A flight data transmitting and storing system for an aircraft comprising:
an acquisition device on the aircraft comprising
a cockpit microphone in the cockpit of the aircraft for detecting a first set of flight data, and
a set of flight parameter sensors for detecting a second set of flight data;
a first storage device on the aircraft comprising
a cockpit voice recorder for storing the first set of flight data, and
a flight data recorder for storing the second set of flight data;
a transmission device on the aircraft for transmitting the first and the second set of flight data outside the aircraft;
a satellite network for receiving and re-transmitting the first and second set of flight data transmitted from the transmission device; and
a central data repository on the ground for receiving and storing the first set and the second set of flight data re-transmitted from the satellite network.

21. The flight data transmitting and storing system of claim 20, further including:
a global positioning satellite sensor system on board the aircraft for determining the precise position of the aircraft and outputting a position data signal indicating the position of the aircraft to be included within the flight data.

22. The flight data transmitting and storing system of claim 20, further including:
a ground transponder system on board the aircraft for determining the position of the aircraft and outputting a position data signal indicating the position of the aircraft for including on the transmitted flight data.

23. The flight data transmitting and storing system in claim 20 wherein the transmission device comprises an air relay module coupled between the acquisition device and the storage device, and the air relay module which is activated by an alert event instantaneously transmits the first set and the second set of flight data detected by the acquisition device.

24. The flight data transmitting and storing system in claim 20 wherein the first and the second of flight data transmitted by the transmission device are in a predetermined communication format including a set of flight parameters of the aircraft which is stored in the air relay module.

25. The flight data transmitting and storing system in claim 20, further comprising:
a disaster transmit module coupled to the storage device, and the disaster transmit module being activated by an emergency condition to instantaneously transmit the first set and the second set of flight data stored in the storage device.

26. The flight data transmitting and storing system in claim 25 wherein the first and second set of flight data transmitted by the disaster transmit module is compressed before the transmission, and the compressed flight data transmitted is in a predetermined communication format including a set of flight parameters of the aircraft which is stored in the disaster transmit module in advance.

27. A flight data transmitting and storing method for an aircraft comprising steps of:
(a) detecting a first set of flight data by a cockpit microphone located in the cockpit of the aircraft and detecting a second set of flight data by a set of flight parameter sensors;
(b) collecting the first and second set of flight data by a flight data acquisition unit;
(c) storing the first set of flight data on a cockpit voice recorder and storing the second set of flight data on a flight data recorder; and
(d) transmitting the first and the second set of flight data to ground by a transmission device while the aircraft is in flight.

28. The flight data transmitting and storing method in claim 27, further comprising:
(e) receiving and then re-transmitting the flight data transmitted from the transmission device by a satellite network; and
(f) receiving the flight data re-transmitted from the satellite network by a central data repository on the ground and storing the flight data thereon.

29. The flight data transmitting and storing method in claim 28 wherein the step (d) of transmitting the first and the second set of flight data comprises:
activating the transmission device if an alert event is happened; and
transmitting instantaneously the first and the second set of flight data simultaneously with the flight data being sent by the cockpit microphone and the set of flight parameter sensors in a predetermined communication format including a set of flight parameters of the aircraft which is stored in the transmission device in advance.

30. The flight data transmitting and storing method in claim 28 wherein the step (d) of transmitting the first and the second set of flight data comprises:
activating the transmission device if an emergency condition is happened; compressing the first and second set of flight data stored in the cockpit voice recorder and the flight data recorder, respectively;
transmitting instantaneously the compressed flight data in a predetermined communication format including a set of flight parameters of the aircraft which are stored on the aircraft that are recorded data from this aircraft.

31. A flight data transmitting and storing method for an aircraft comprising steps of:
(a) storing a set of flight parameters of the aircraft;
(b) detecting and collecting sets of flight data of the aircraft;
(c) storing the sets of flight data on the aircraft;
(d) transmitting the flight parameters and the sets of flight data detected to a central data repository when an alert event is happened; and
(e) transmitting a disaster alert to a emergency center and transmitting the flight parameters and the sets of flight data stored to the central data repository when an emergency condition is happened.

32. The flight data transmitting and storing method for an aircraft in claim 31 wherein the step of (d) comprises:
checking whether the alert event is happened;
continuing to check whether the alert event has happened, if the alert event was not happened; and
transmitting the flight parameters and the sets of flight data detected to the central data repository and storing the sets of flight data thereon, if the alert event was happened.

33. The flight data transmitting and storing method for an aircraft in claim 32 wherein the step of (e) comprises:
checking whether the emergency condition has happened;
continuing to check whether the emergency condition has happened, if the emergency condition was not happened; and
transmitting a disaster alert to a emergency center, compressing the sets of flight data stored on the aircraft, transmitting the flight parameters and the compressed sets of flight data to the central data repository, and storing the compressed sets of flight data thereon, if the emergency condition was happened.
